(19) United States
(12) Patent Application Publication
(10) Pub. No.: US 2015/0292261 A1
(43) Pub. Date: Oct. 15, 2015

(54) ROLLER CURTAIN STRUCTURE

(71) Applicant: Tser Wen CHOU, Taipei City (TW)

(72) Inventor: Tser Wen CHOU, Taipei City (TW)

(21) Appl. No.: 14/248,736

(22) Filed: Apr. 9, 2014

(51) Int. Cl. E06B 9/262; E06B 9/40

(52) U.S. Cl. CPC E06B 9/262; E06B 9/40; E06B 2009/2627

(57) ABSTRACT

A roller curtain structure includes a cord winder seat, two curtain sheets, several sunshade fabrics and two lower weights. The two curtain sheets are connected with two sides of the reel and naturally suspended therefrom at equal height. The lower weights are connected to bottom ends of the two curtain sheets to apply downward pull force to the curtain sheet so as to provide a smooth sunshade face. When it is desired to shade the sunlight, the reel is rotated to wind one of the curtain sheets to lift one of the two lower weights and make the two curtain sheets get closer to each other. Accordingly, the sunshade angle of the sunshade fabrics connected between the curtain sheets is synchronously adjusted to partially or fully shade the sunlight.

### BACKGROUND OF THE INVENTION

1. Field of the Invention

The present invention relates generally to an improved roller curtain structure, and more particularly to a roller curtain structure, which can change the sunshade form and enhance the sunshade effect.

2. Description of the Related Art

A conventional roller curtain has a curtain sheet made of fully nontransparent fabric material for shading sunlight. According to the sunlight projection angle, the curtain sheet is rolled up or unrolled down to provide different sunshade effects. However, the sunlight projection range is considerably large so that the sunlight will be still projected through the gap between the curtain sheet and the window into the room. Therefore, the sunshade effect of the conventional roller curtain is not optimal.

Moreover, in order to solve the above problem of the conventional roller curtain, an improved curtain structure has been developed, in which the angle of the slats can be changed to achieve better sunshade effect. Such curtain structure is able to solve the sunshade problem of the conventional roller curtain. However, the slats of the curtain can be hardly positioned in a vertical position. Therefore, the slats cannot be fully closed so that there are still gaps between the slats in a closed state. As a result, the sunlight will be still projected through the gaps into the room. Accordingly, the sunshade effect is also not optimal.

### SUMMARY OF THE INVENTION

It is therefore a primary object of the present invention to provide a roller curtain structure. Two curtain sheets are fixedly connected with two sides of the reel of the cord winder seat and naturally suspended therefrom at equal height in a parallel state. When it is desired to shade the sunlight, the reel is rotated to wind one of the curtain sheets and make the two curtain sheets get closer to each other. Accordingly, the sunshade angle of the sunshade fabrics connected between the curtain sheets is synchronously adjusted to selectively fully or partially shade the sunlight.

To achieve the above and other objects, the roller curtain structure of the present invention includes: a cord winder seat including a pull cord seat and a reel drivingly connected with the pull cord seat; two curtain sheets respectively fixedly connected with two sides of the reel and naturally suspended therefrom, the curtain sheets having entirely transparent sheet faces; several sunshade fabrics each having two seamed sides, the seamed sides of the sunshade fabrics being respectively connected to the two curtain sheets to connect the sunshade fabrics between the two curtain sheets at equal intervals at equal intervals, the sunshade fabrics having nontransparent shading faces; and two lower weights including a first lower weight and a second lower weight. Each lower weight includes a first casing, a second casing, several perpendicularly protruding latch boards and two side cap bodies, which are correspondingly latched and assembled with each other. The first lower weight is further provided with several weight bodies. The two curtain sheets are disposed on two opposite sides of the reel. Due to the weight of the two lower weights, the two curtain sheets are naturally suspended at equal height, whereby sunlight can be projected through the transparent sheet faces of the curtain sheets into a window. When shading the sunlight, the reel is rotated to wind one of the curtain sheets to make the two lower weights and curtain sheets get closer to each other, whereby the sunshade angle of the sunshade fabrics is synchronously adjusted to partially or fully shade the sunlight.

The present invention can be best understood through the following description and accompanying drawings, wherein:

### BRIEF DESCRIPTION OF THE DRAWINGS

FIG. 1 is a perspective view of the roller curtain of the present invention;

FIG. 2 is a perspective exploded view of the lower weight of the present invention;

FIG. 3 is a perspective assembled view of the lower weight of the present invention;

FIG. 4 is a sectional assembled view of the lower weight of the present invention;

FIG. 5 is a perspective view showing that a cap body is assembled with the lower weight;

FIG. 6 is a perspective assembled view of the completed lower weight of the present invention;

FIG. 7 is a view showing that the lower weights are positioned at equal height;

FIG. 8 is a view showing that the assembly of the present invention is completed;

FIG. 9 is a view according to FIG. 8, showing the operation of the present invention;

FIG. 10 is a view showing the winding operation of the present invention;

FIG. 11 is a view showing that the present invention is in a full sunshade state;

FIG. 12 is a view showing the present invention is reversely operated;

FIG. 13 is a view showing the reverse winding operation of the present invention; and

FIG. 14 is a view showing that the present invention is in a partial sunshade state.

### DETAILED DESCRIPTION OF THE PREFERRED EMBODIMENT

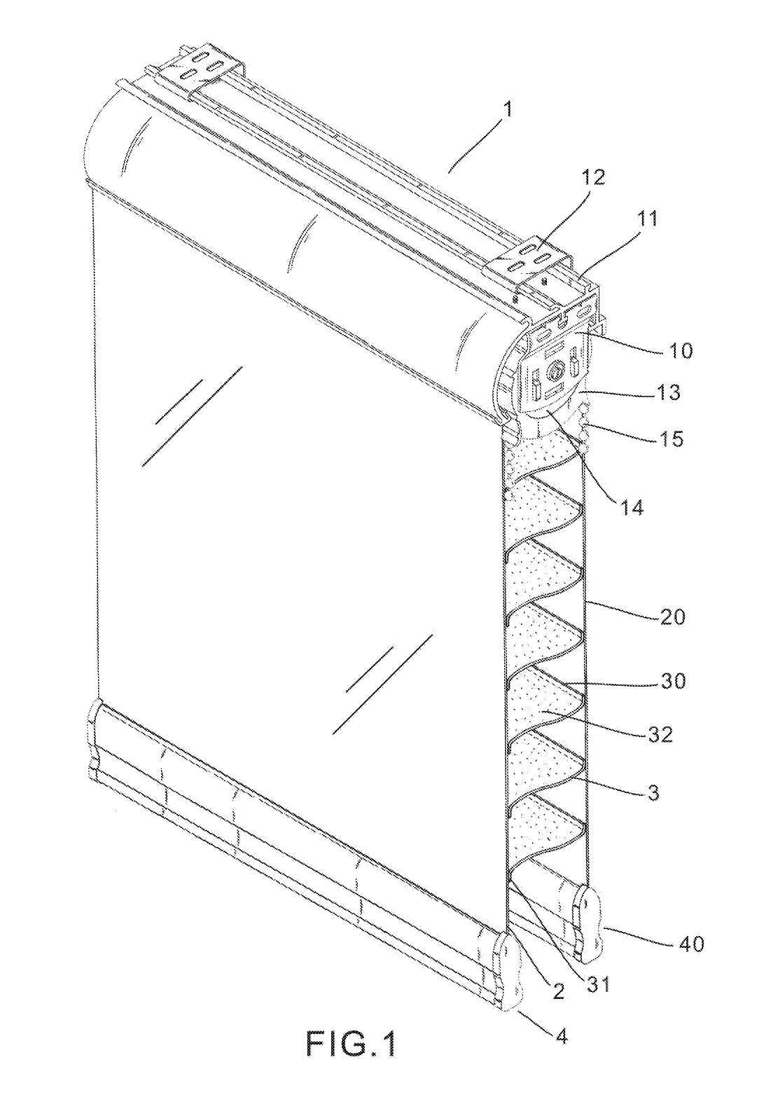

Please refer to FIG. 1. The roller curtain structure of the present invention includes a cord winder seat 1, two curtain sheets 2, 20, several sunshade fabrics 3 connected between the curtain sheets 2, 20 at equal intervals and two lower weights 4, 40 fixedly connected with lower ends of the two curtain sheets 2, 20.

As shown in FIG. 1, the cord winder seat 1 is fixedly disposed on a rail 11 via a bracket 10. The rail 11 is fixed on a wall face by means of fixing supports 12. The cord winder seat 1 mainly includes a pull cord seat 13, a reel 14 drivingly connected with the pull cord seat 13 and a bead cord 15.

The curtain sheets 2, 20 are fixedly connected with two sides of the reel 14 and naturally suspended therefrom. The curtain sheets 2, 20 have entirely transparent sheet faces. Two seamed sides 30, 31 of the sunshade fabrics 3 are respectively connected to the two curtain sheets 2, 20 at equal intervals. One of the seamed sides 30, 31 is seamed upward, while the other of the seamed sides 30, 31 is seamed downward to form a reverse structure. The sunshade fabrics 3 have nontransparent shading faces 32.

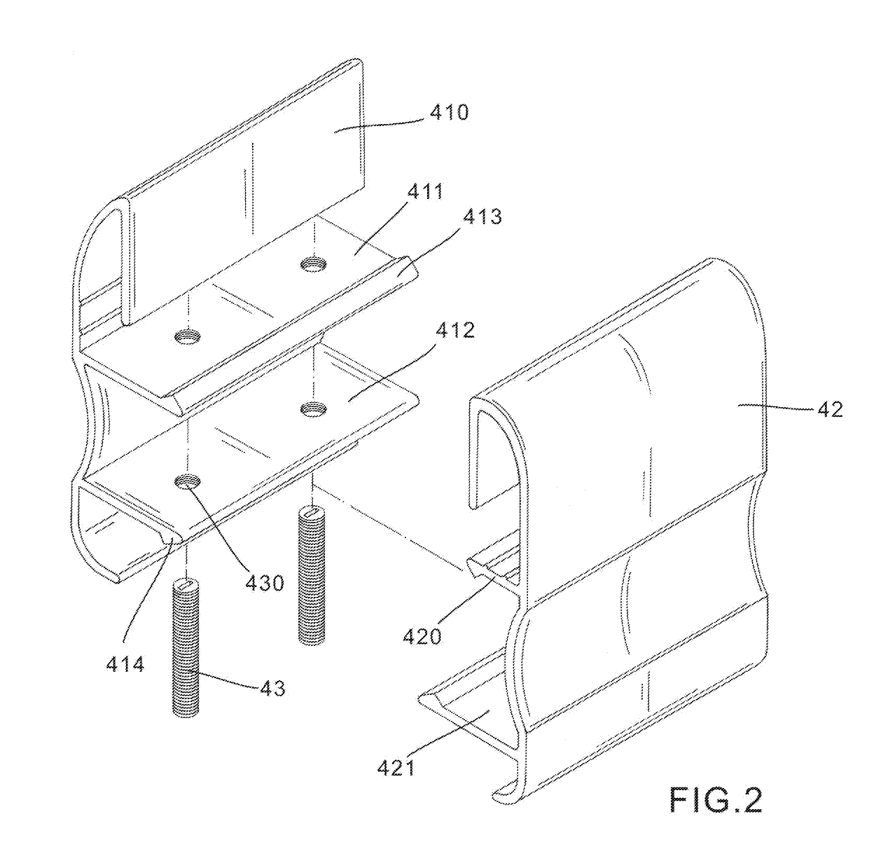

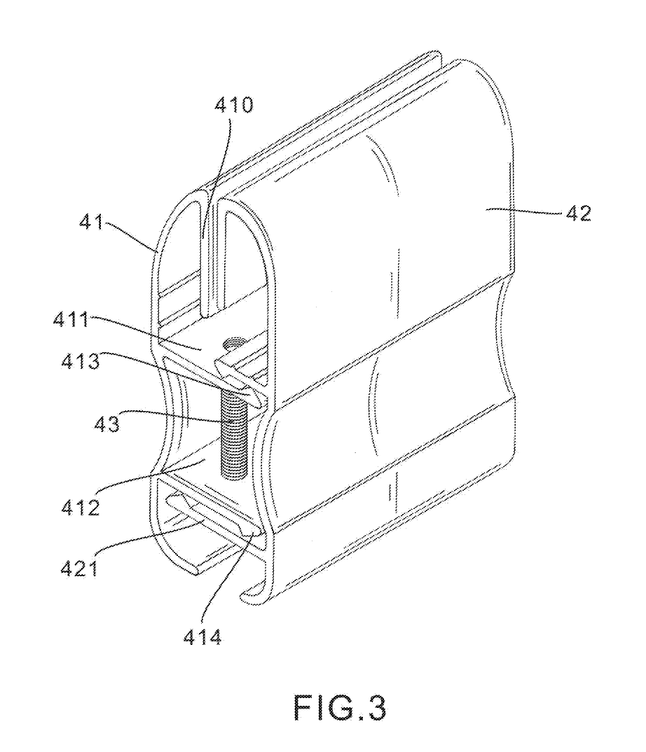

The two lower weights 4, 40 have identical structures so that only one of the lower weights 4, 40 will be described hereinafter. Please refer to FIGS. 2 and 3. The lower weight 4 includes a first casing 41 and a second casing 42. An upper end of the first casing 41 has an upright fixing face 410 for fixedly connecting with the lower end of the curtain sheet 2. Two latch boards 411, 412 integrally horizontally extend from an inner face of the first casing 41. Each of the latch boards 411, 412 has a free end formed with a hook-like latch structure 413, 414 for correspondingly latching with the horizontally extending latch boards 420, 421 of the second casing 42. The latch boards 411, 412 are formed with threaded holes 430 for fixing screws 43 to pass therethrough. Accordingly, the two casings 41, 42 can be fixedly assembled with each other by means of the fixing screws 43 (as shown in FIG. 3).

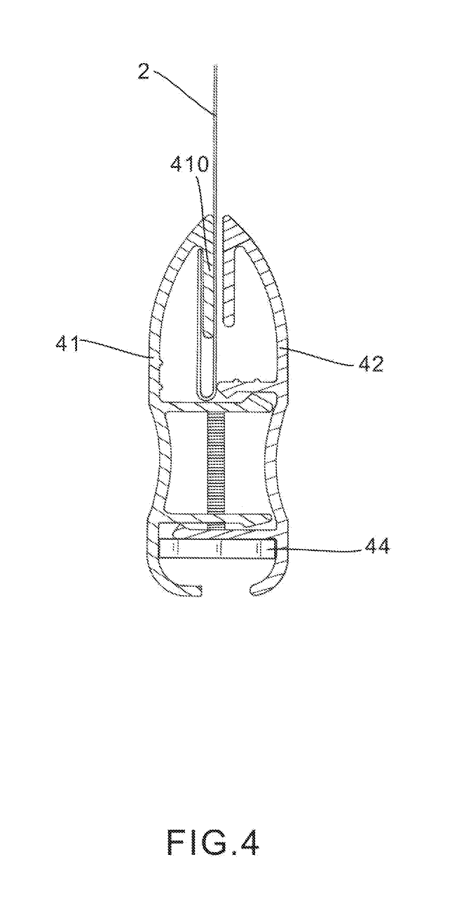

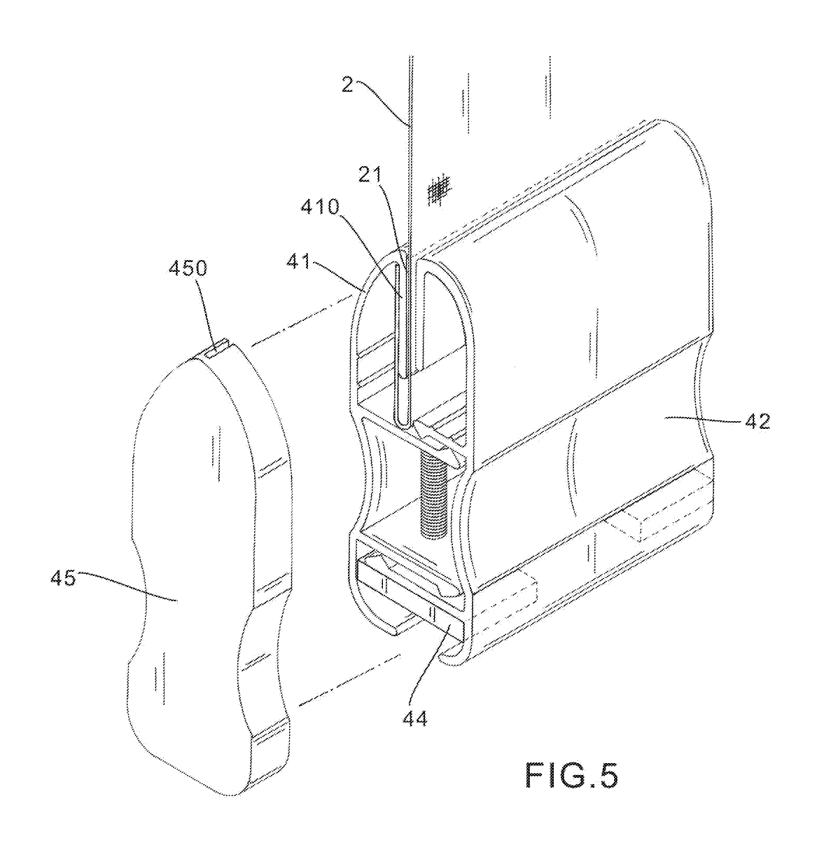

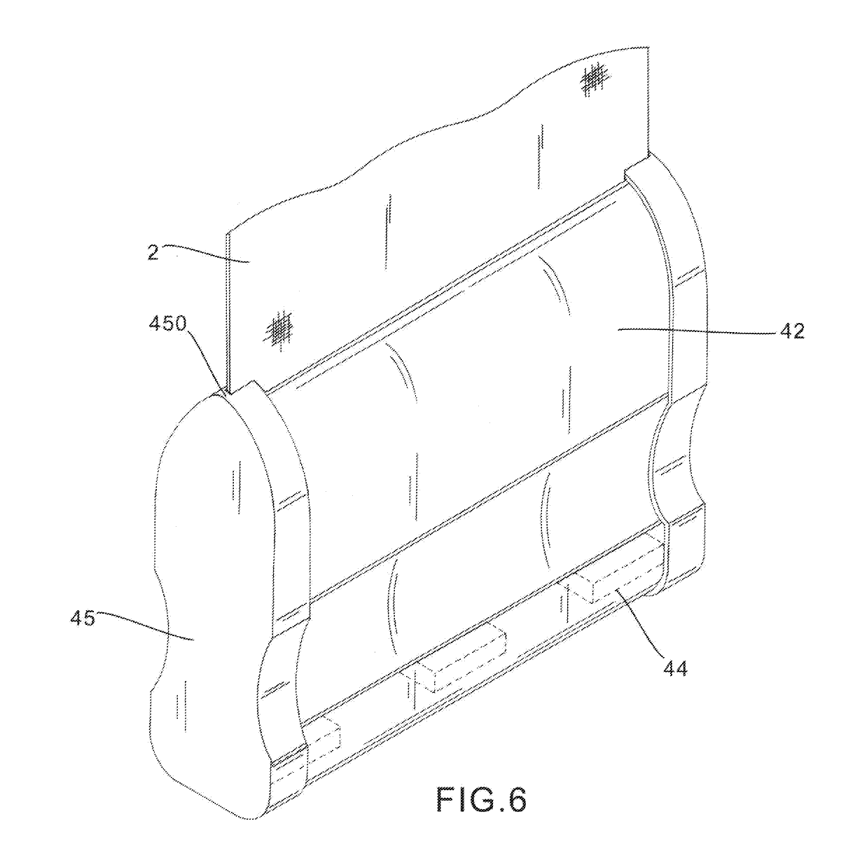

As shown in FIGS. 4 and 5, when assembled, the lower end of the curtain sheet 2 is affixed to the fixing face 410 of the first casing 41 by a fixing plate 21 and integrally connected with the first casing 41. After the lower weight 4 is assembled, a space is defined at the lower end of the lower weight 4. Weight bodies 44 are respectively positioned in a front section, a middle section and a rear section of the space. Each lateral opening of the lower weight 4 is blocked with a cap body 45 (as shown in FIG. 5). The cap body 45 has a configuration similar to that of the lower weight 4 and has a size slightly larger than that of the lower weight 4. An upper end of the cap body 45 is formed with a split 450 for the curtain sheet 2 to pass through in immediate adjacency to an outer end face of the cap body 45 (as shown in FIG. 6). Under such circumstance, the gap between the curtain sheet 2 and the window is minimized.

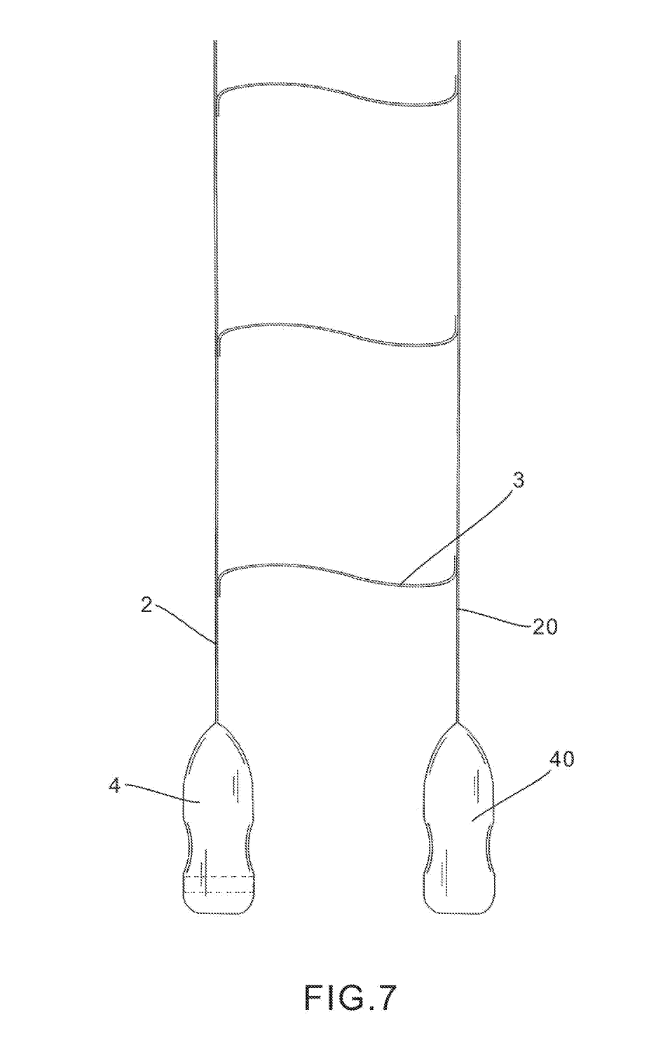

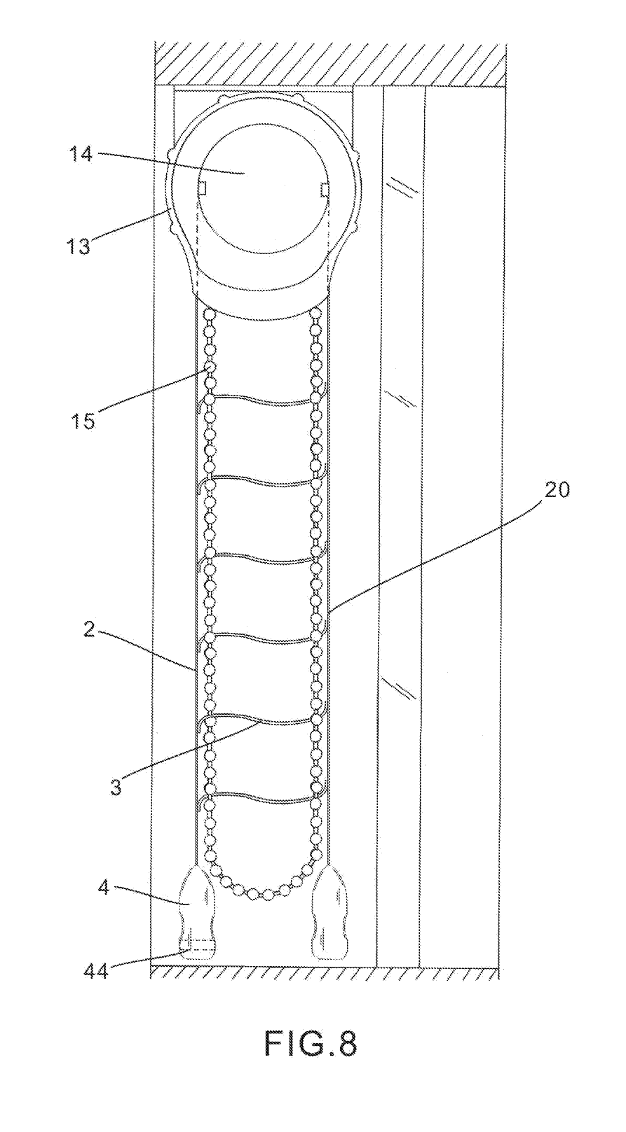

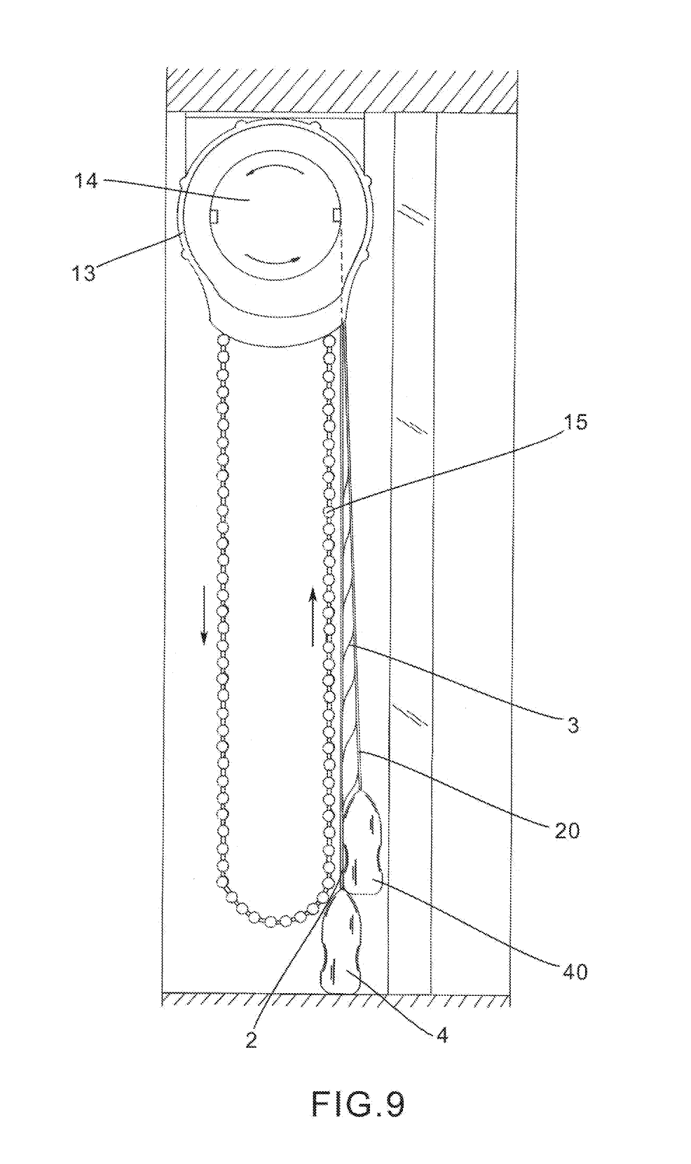

After the two lower weights 4, 40 are assembled with the two curtain sheets 2, 20 (as shown in FIG. 7), the top ends of the curtain sheets 2, 20 are respectively fixedly connected to two sides of the reel 14 of the pull cord seat 13. By means of pulling the bead cord 15, the reel 4 is controllably rotatable to drive the curtain sheets 2, 20 one up and one down (as shown in FIGS. 8 and 9).

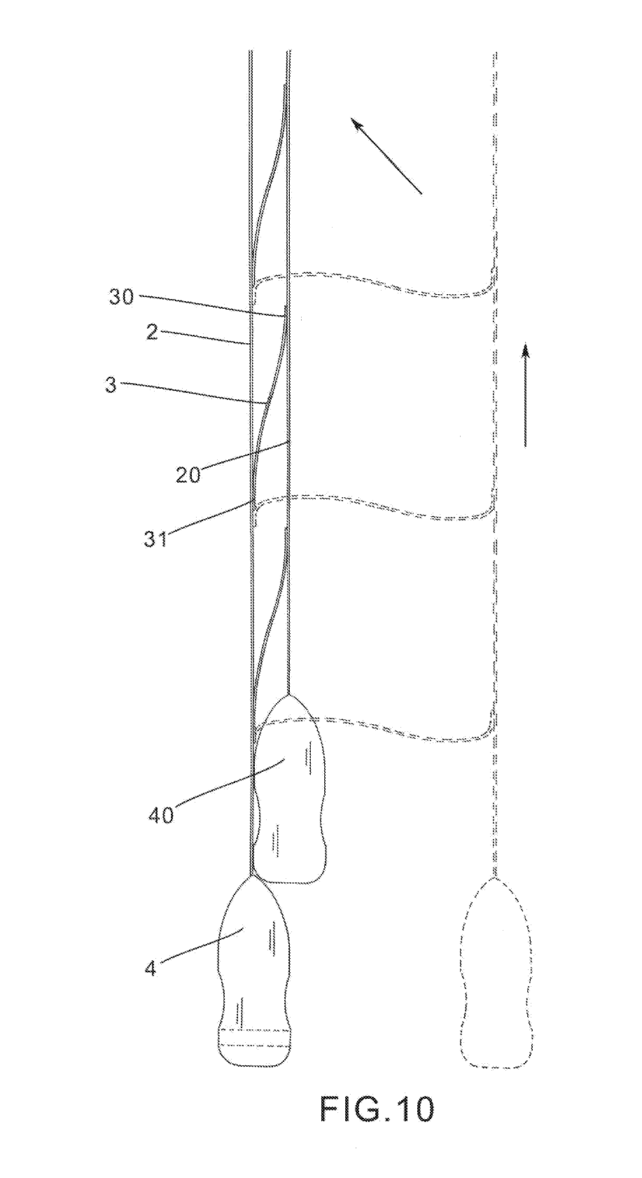

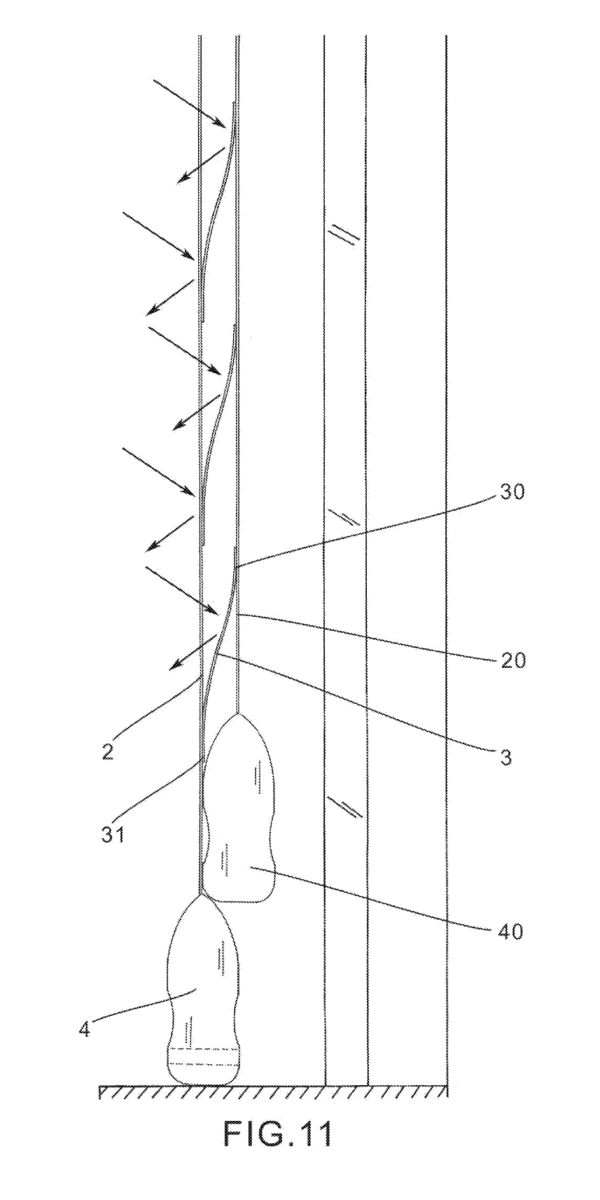

Referring to FIG. 9, in use of the roller curtain of the present invention, the left side bead cord 15 is pulled downward to counterclockwise rotate the reel 4, whereby the curtain sheet 20 is lifted, while the other curtain sheet 2 is driven by the reel 14 to get closer to the curtain sheet 20. When the lower weight 40 is lifted to the upper end of the lower weight 4, the sunshade fabrics 3 are synchronously moved from the horizontal position to an angular position for shading the sunlight. At this time, the seamed sides 30, 31 are straightened to overlap each other (as shown in FIG. 10). The height of the two curtain sheets 2, 20 is changed to make the sunshade fabrics 3 angularly displace and overlap each other so as to provide a full sunshade effect. Accordingly, when sunlight is projected onto the curtain sheet 2, the sunlight is totally interrupted from entering the room to achieve a full sunshade effect (as shown in FIG. 11).

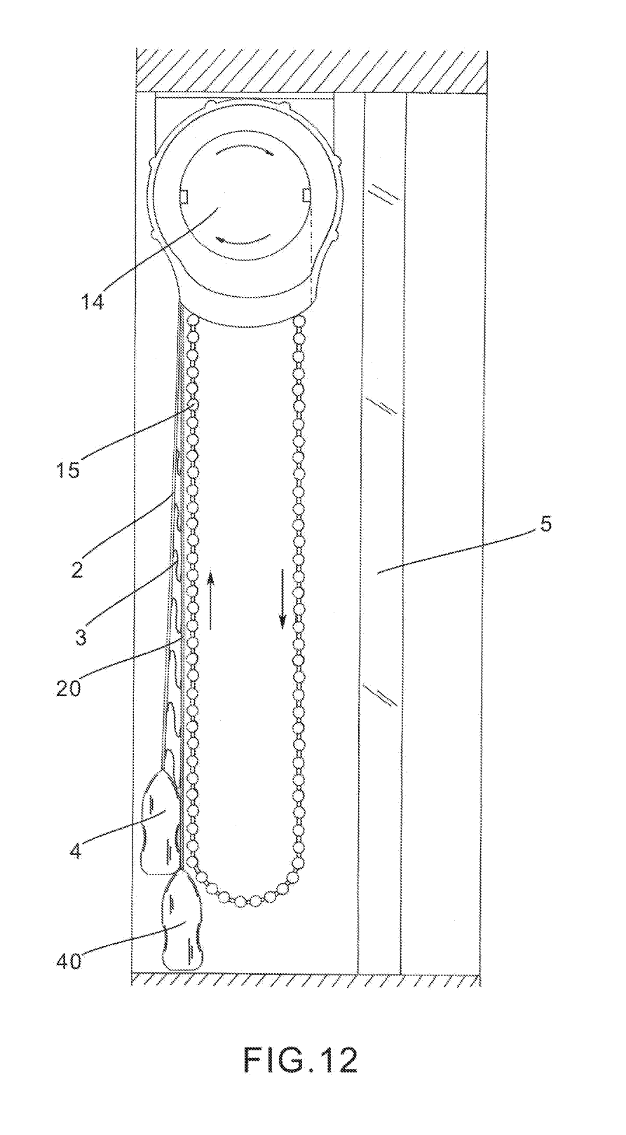

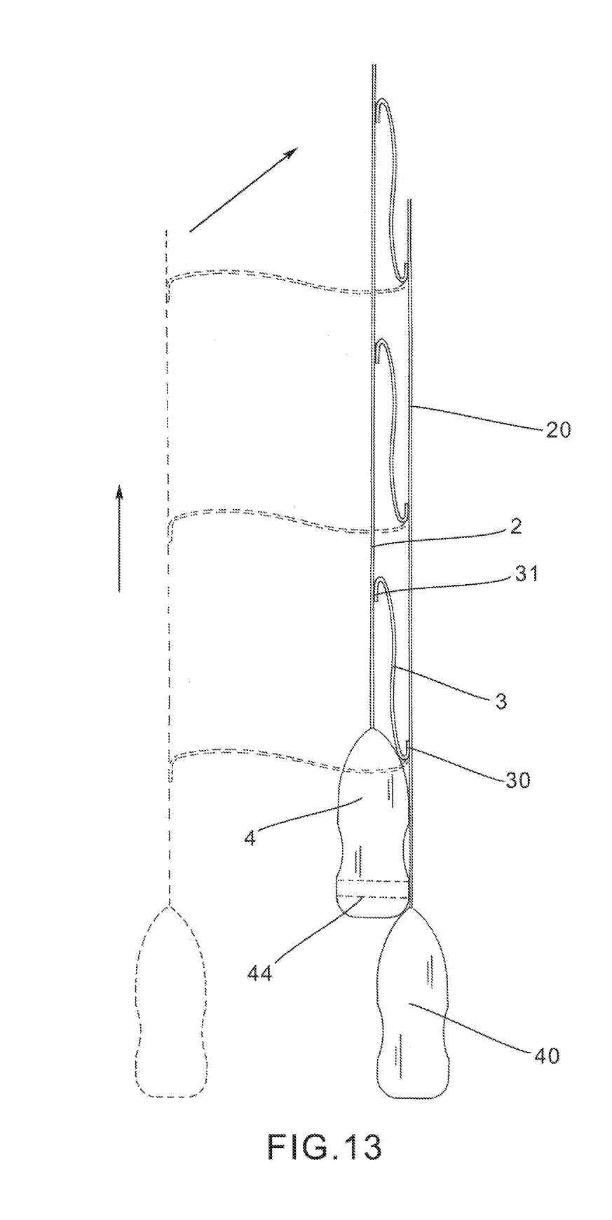

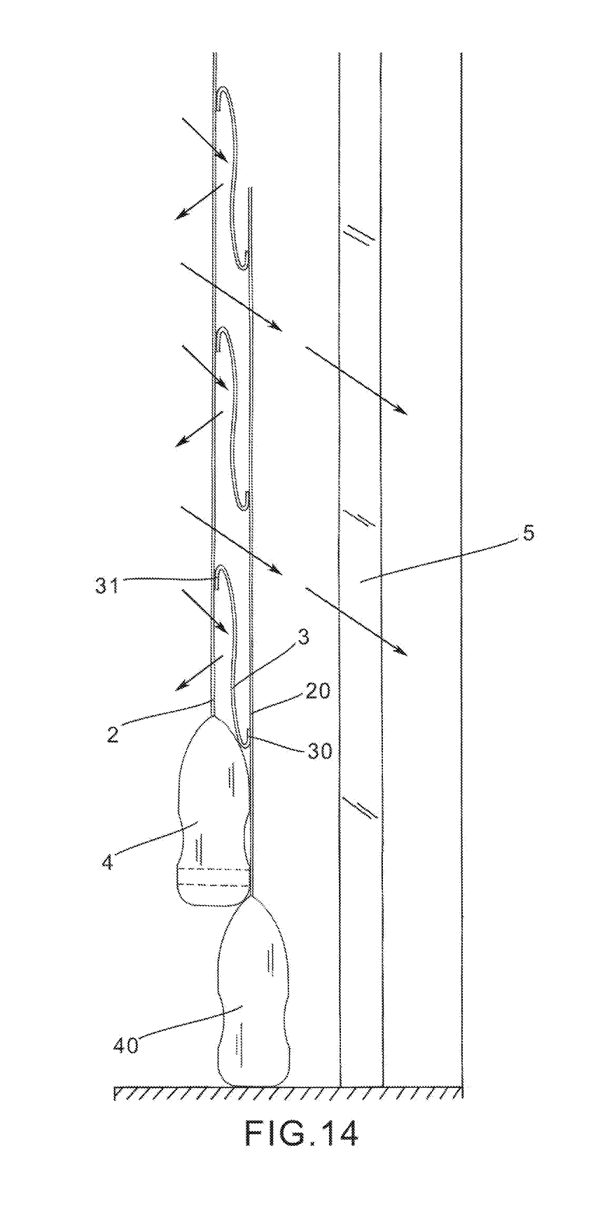

In the case that a user desires to partially shade the sunlight, the user can clockwise rotate the reel 4 (as shown in FIG. 12) to lift the curtain sheet 2. At this time, the right side curtain sheet 20 is driven by the reel 14 to get closer to the curtain sheet 2 until the lower weight 4 is lifted to the upper end of the lower weight 40. Under such circumstance, the sunshade fabrics 3 are curled along the seamed sides 30, 31 (as shown in FIG. 13), whereby there are gaps between the sunshades 3. In this case, the sunlight can be projected through the gaps onto the glass 5 of the window (as shown in FIG. 14) to achieve a partial sunshade effect.

The above embodiment is only used to illustrate the present invention, not intended to limit the scope thereof. Many modifications of the above embodiment can be made without departing from the spirit of the present invention.

What is claimed is:

1. A roller curtain structure comprising:
a cord winder seat including a pull cord seat, a reel drivingly connected with the pull cord seat and a bead cord;
two curtain sheets respectively fixedly connected with two sides of the reel and naturally suspended therefrom, the curtain sheets having entirely transparent sheet faces;
several sunshade fabrics each having two seamed sides, the seamed sides of the sunshade fabrics being respectively connected to the two curtain sheets to connect the sunshade fabrics between the two curtain sheets at equal intervals at equal intervals, the sunshade fabrics having nontransparent shading faces; and
two lower weights including a first lower weight and a second lower weight, each lower weight including a first casing, a second casing, several perpendicularly protruding latch boards and two side cap bodies, which are correspondingly latched and assembled with each other, the first lower weight being further provided with several weight bodies, the two curtain sheets being disposed on two opposite sides of the reel, due to the weight of the two lower weights, the two curtain sheets being naturally suspended at equal height, whereby sunlight can be projected through the transparent sheet faces of the curtain sheets into a window, when shading the sunlight, the reel being rotated to wind one of the curtain sheets to make the two lower weights and curtain sheets get closer to each other, whereby the sunshade angle of the sunshade fabrics is synchronously adjusted to partially or fully shade the sunlight.

2. The roller curtain structure as claimed in claim 1, wherein one of the seamed sides of the sunshade fabric is seamed upward, while the other of the seamed sides is seamed downward to form an S-shaped structure.

3. The roller curtain structure as claimed in claim 1, wherein each of the first and second lower weights is provided with a weight body.

4. The roller curtain structure as claimed in claim 1, wherein each of the perpendicularly protruding latch boards of the first and second lower weights has a free end formed with a hook-like latch structure.

5. The roller curtain structure as claimed in claim 1, wherein the weight bodies of the first lower weight are respectively positioned in a front section, a middle section and a rear section of a lower end space of the first lower weight.
